(19) United States
(12) Patent Application Publication
(10) Pub. No.: US 2014/0164678 A1
(43) Pub. Date: Jun. 12, 2014

(54) INTELLIGENT DETECTION DEVICE OF SOLID STATE HARD DISK COMBINING A PLURALITY OF NAND FLASH MEMORY CARDS AND DETECTING METHOD FOR THE SAME

(71) Applicant: KEY TECHNOLOGY CORPORATION, Hsinchu (TW)

(72) Inventors: Chien-Hung LAN, Hsinchu (TW); Yu-Shun CHANG, Hsinchu (TW)

(73) Assignee: KEY TECHNOLOGY CORPORATION, Hsinchu (TW)

(21) Appl. No.: 13/712,622

(22) Filed: Dec. 12, 2012

(51) Int. Cl. G06F 12/02

(52) U.S. Cl. CPC G06F 12/0246
USPC 711/103

(57) ABSTRACT

An intelligent detection device of solid state hard disks combining a plurality of NAND flash memory card, and detecting method for the same. Wherein, a central processing unit (CPU) controls a control unit, and is connected electrically to a plurality of flash card insertion slots, for a plurality of NAND flash memory card to be inserted in. Said control unit reads parameters of said flashcards, and transmits said parameters back to said CPU, for it to determine status of each said NAND flash memory card, and display status of each said NAND flash memory card on at least a status display unit. Said intelligent detection device is capable of integrating storage space of a plurality of NAND flash memory card into a larger storage space, and detecting status of each said NAND flash memory card, to inform users to backup data in time.

### BACKGROUND OF THE INVENTION

1. Field of the Invention

The present invention relates to a redundant disk array, and in particular to an intelligent detection device of solid state hard disk capable of integrating storage space of a plurality of NAND Flash memory cards by combining such cards, and a detecting method for the same.

2. The Prior Arts

Redundant Array of Inexpensive Disks (RAID), also referred to as hard disk arrays. Its basic concept of design is to combine a plurality of hard disks into a hard disk array, to achieve or even surpass a single hard disk of large storage capacity. Compared with the single piece hard disk, the hard disk array has the advantages of enhanced data integration, raised debugging ability, and increased processing capability.

In brief, the hard disk array combines a plurality of hard disks into a logic block. Therefore, the operating system of the computer treats the plurality of hard disks in the hard disk array as one hard disk. In general, the hard disk array is used in a server computer, and it consists of a plurality of hard disks of the same format. Since, it is not capable of detecting instantly to know the status of each of the hard disks, so it can not inform the user to repair the damaged hard disk in time. When finally the user is aware of the situation, the data on the hard disk is lost and can not be recovered. In addition, the volume of the hard disk array is rather large, it is not convenient for carriage.

Therefore, presently, the design and performance of the hard disk array is not quite satisfactory, and it has much room for improvements.

### SUMMARY OF THE INVENTION

In view of the problems and shortcomings of the prior art, the present invention provides an intelligent detection device of solid state hard disk capable of combining a plurality of NAND flash memory card, and a detecting method for the same. Wherein, the user is informed in time to make backup copies of data or replace the damaged flashcards in time, so data loss is less likely to occur, to improve the shortcomings of the prior art.

A major objective of the present invention is to provide an intelligent detection device of solid state hard disks combining a plurality of NAND flash memory card, and detecting method for the same. Wherein, the storage space of a plurality of NAND flash memory card can be integrated into a larger storage space, to increase access speed. Also, the status of each NAND flash memory card can be detected in time to inform the user to backup data or replace the damaged cards.

Another objective of the present invention is to provide an intelligent detection device of solid state hard disks combining a plurality of NAND flash memory card, and detecting method for the same, such that the damaged NAND flash memory card can be replaced separately, without the need to replace the whole disk array, thus achieving cost saving, speedy repair and maintenance.

A further objective of the present invention is to provide an intelligent detection device of solid state hard disks combining a plurality of NAND flash memory card, and detecting method for the same, so as to simplify the manufacturing process and save the cost spent on testing the cards.

A yet another objective of the present invention is to provide an intelligent detection device of solid state hard disks combining a plurality of NAND flash memory card, and detecting method for the same, such that it is compact in size, and is convenient for carriage.

In order to achieve the above-mentioned objective, the present invention provide an intelligent detection device of solid state hard disks combining a plurality of NAND flash memory card, and detecting method for the same, comprising: a central processing unit (CPU), a control unit, a plurality of flash card insertion slots, and at least a status display unit. Wherein, the CPU controls the control unit, that is connected electrically to a plurality of flash card insertion slots, to accommodate a plurality of inserted NAND flash memory card, so that the control unit can read the parameters of each NAND flash memory card. Then, the control unit transmits the parameter of each NAND flash memory card to the CPU, to determine the status of each NAND flash memory card. Also, the CPU controls at least a status display unit to display the status of each of the NAND flash memory card.

Moreover, the present invention provides a detecting method for an intelligent detection device of solid state hard disks combining a plurality of NAND flash memory card, comprising the following steps: read Flash Identification parameter from each plurality of NAND flash memory card, and determine the specification of the cards; read the parameters of the plurality of NAND flash memory card, and transmit back the parameters to determine the status of each of the NAND flash memory card; and send out a display signal to the status display unit, to display the statuses of cards.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of an intelligent detection device of solid state hard disks combining a plurality of NAND flash memory card according to an embodiment of the present invention;

FIG. 2 is a flowchart of the steps of a detecting method for an intelligent detection device of solid state hard disks combining a plurality of NAND flash memory card according to an embodiment of the present invention; and

FIG. 3 is a schematic diagram of an intelligent detection device of solid state hard disks combining a plurality of NAND flash memory card according to another embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings. And, in the following, various embodiments are described in explaining the technical characteristics of the present invention.

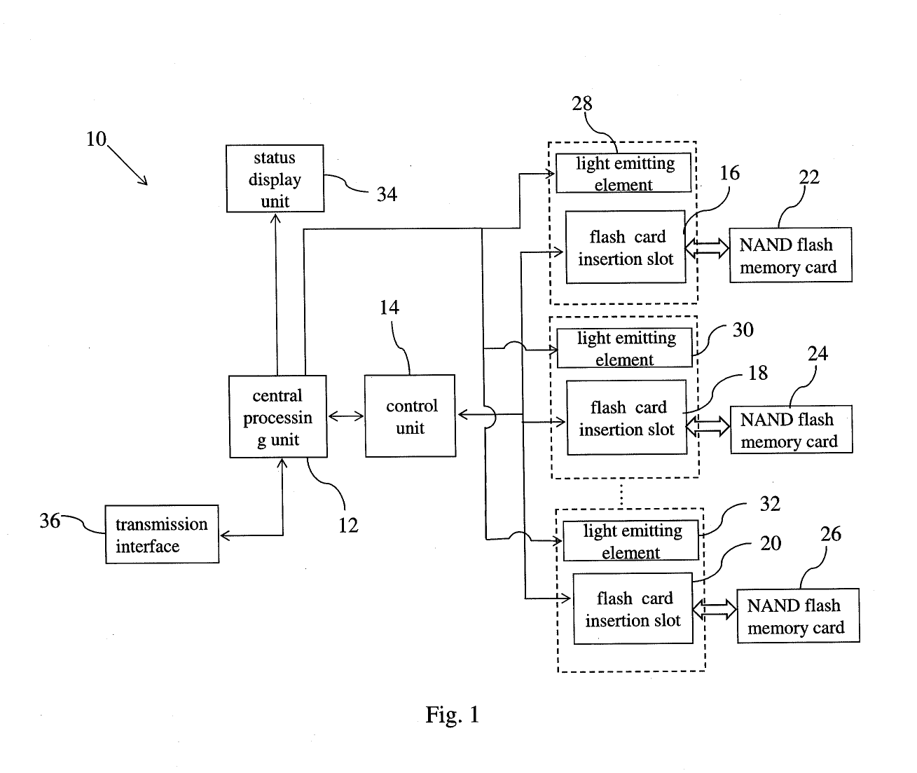

The present invention provides an intelligent detection device of solid state hard disks combining a plurality of NAND flash memory card. Refer to FIG. 1 for an intelligent detection device of solid state hard disks combining a plurality of NAND flash memory card according to an embodiment of the present invention. As shown in FIG. 1, the intelligent detection device of solid state hard disks combining a plurality of NAND flash memory card 10 includes: a central processing unit (CPU) 12, a control unit 14, a plurality of flash card insertion slots 16, and at least a status display unit 34. Wherein, the CPU 12 is connected electrically to a control unit 14, to control the control unit 14. The control unit 14 is connected electrically to the plurality of flash card insertion slots 16, to accommodate the plurality of inserted NAND flash memory card 22. The NAND flash memory card 22 can be of various types such as SD, TF, XD, eMMC, CF, MS, to form the solid state hard disk of NAND flash memory card. As such, the control unit 14 can read the Spare Field, Reserved Block and User Defined Registers of each NAND flash memory card 22. The parameters are for example, Flash Identification, Erase Count, Error Correcting Code (ECC), Program/Erase Status, Cyclic Redundancy Check (CRC), Parity Check, User Defined Parameters, Bad Block Number, etc. of the NAND flash memory card 22.

In the present embodiment, the CPU 12 is provided with a Self-Monitoring Analysis And Reporting Technology (SMART) command and a Vendor Specific Command, for it to send orders through the control unit 14 to read and determine the status of the flash memory cards 22. The control unit 14 sends the read parameters back to the CPU 12, for it to determine the Flash Identification and status of each NAND flash memory card 22, and the CPU transmits signal to a status display unit 34 to display status of each card. The status display unit 34 can be a liquid crystal screen, so that the CPU 12 can display the status of each NAND flash memory card 22 on the liquid crystal screen in characters or graphs. In addition, the status display unit 34 can be a plurality of light emitting elements 28, such as light-emitting-diode (LED), and are located in the corresponding flash card insertion slots 16, and under the control of CPU 12, display status of each NAND flash memory card 22. The CPU 12 is further connected electrically to at least a transmission interface 36, to connect electrically the intelligent detection device of solid state hard disks combining a plurality of NAND flash memory card 10 to a computer, for transmitting data to that computer, so that the computer is able to display status of each NAND flash memory card 22. Wherein, the transmission interface 36 can be a Universal Series Bus (USB) or a serial ATA.

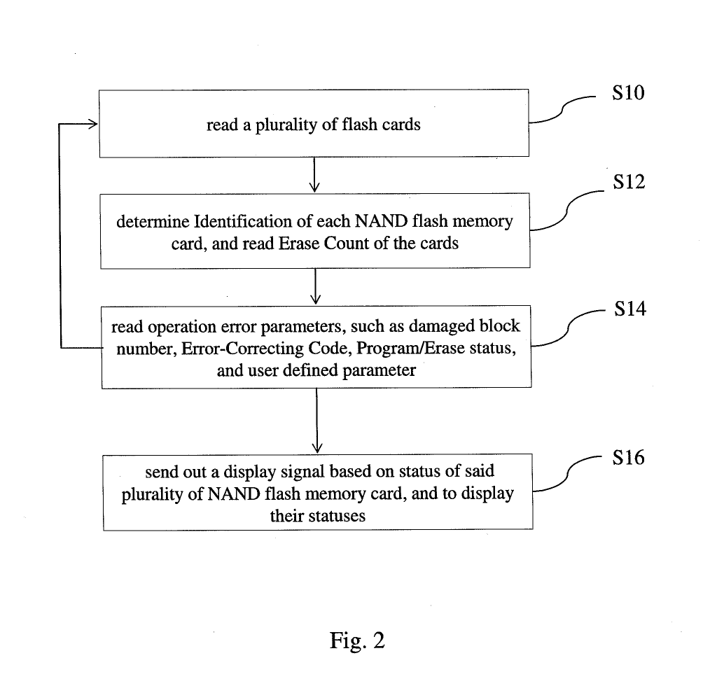

Next, refer to FIG. 2 for a flowchart of the steps of a detecting method for an intelligent detection device of solid state hard disks combining a plurality of NAND flash memory card according to an embodiment of the present invention. Also, refer to FIG. 1. As shown in FIG. 2, firstly, in step S10, the CPU 12 reads through the control unit 14, the plurality of NAND flash memory card 22, 24, and 26 inserted in the flash card insertion slots 16, 18, 20. Next, in step S12, the CPU 12 utilizes a Self-Monitoring Analysis And Reporting Technology (SMART) command or a Vendor Specific Command, to send orders through the control unit 14 to read the Flash Identification of the NAND flash memory card 22, 24, and 26, and transmits them to CPU 12, to determine the NAND flash specification of each of the cards 22, 24, and 26. At the same time, the control unit 14 reads the Erase Count in each of the cards 22, 24, and 26, and transmits them to the CPU 12, for it to determine the service life of each of the cards 22, 24, and 26 based on the Erase Count.

Then, in step S14, the control unit 14 reads the error operating parameters, such as Error-Correction Code (ECC), Program/Erase status, Cyclic Redundancy Check (CRC), Parity Check, and user defined parameters, and Bad Block number of the cards 22, 24, and 26, and transmits the parameters to the CPU 12, for it to determine if any of the cards 22, 24, and 26 are damaged based on the parameters, and also monitor the statuses of the cards 22, 24, and 26. Upon completing the step S14, the process returns to step S10, so the control unit 14 reads again the parameters of the NAND flash memory card 22, 24, and 26, and transmits them to the CPU 12, for it to determine the statuses of the cards 22, 24, and 26, and transmit a signal to a status display unit 34, to update thereon the statuses of the cards 22, 24, and 26. 100221 Finally, as shown in step S16, the CPU 12 sends out a display signal to the status display unit 34, for the status display unit 34 to display the status of the cards 22, 24, and 26 to see if they are damaged. In this respect, in case the status display unit 34 is realized through a plurality of light emitting elements 28, 30, and 32, then they are located in the corresponding flash card insertion slots 16, 18, and 20. As such, the CPU 12 will send the corresponding display signals to each of the light emitting elements 28, 30, and 32 based on the statuses of the cards 22, 24, and 26. By way of example, based on the status of the NAND flash memory card 22 inserted in the flash card insertion slot 16, the CPU 12 sends out a display signal to the light emitting element 28, for it to emit light and display the status of the NAND flash memory card 22. Also, based on the status of the NAND flash memory card 24 inserted in the flash card insertion slot 18, the CPU 12 sends a display signal to the light emitting element 30, for it to emit light and display the status of the NAND flash memory card 24. In this respect, the light emitting elements 28, 30, and 32 can be designed to emit lights of different colors based on the statuses of the NAND flash memory card 22, 24, and 26. In the present embodiment, in case the cards 22, 24, and 26 are in a normal status, the light emitting elements 28, 30, and 32 are designed to emit green light; in case the cards 22, 24, and 26 are slightly damaged, the light emitting elements 28, 30, and 32 are designed to emit yellow light, to remind the user to backup data in time; or in case the cards 22, 24, and 26 are damaged and fail to function, the light emitting elements 28, 30, and 32 are designed to emit red light, to remind the user to replace the cards. In addition to the colors of lights mentioned above, they can be varied based on actual requirements to achieve the purpose of reminding the users.

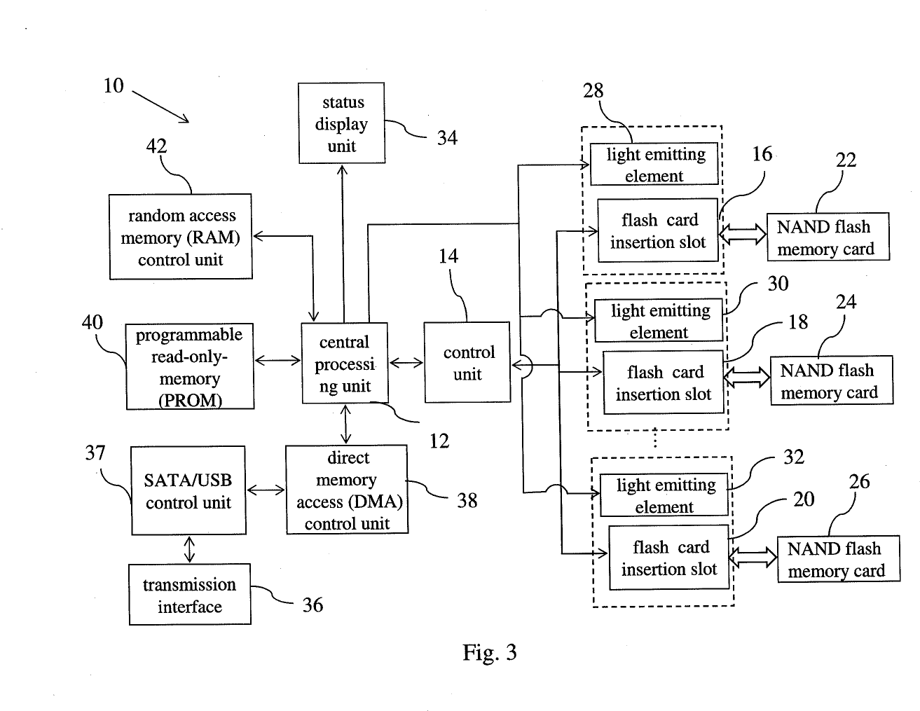

Moreover, refer to FIG. 3 for a schematic diagram of an intelligent detection device of solid state hard disks combining a plurality of NAND flash memory card according to another embodiment of the present invention. As shown in FIG. 3, the intelligent detection device of solid state hard disks combining a plurality of NAND flash memory card 10 can be further provided with a direct memory access (DMA) control unit 38, a programmable read-only-memory (PROM) 40, and a random access memory (RAM) control unit 42. Wherein, the PROM 40 is connected electrically to the CPU 12 and the direct memory access (DMA) control unit 38, while the direct memory access (DMA) control unit 38 and an SATA/USB control unit 37 are connected electrically to the CPU 12, so that the DMA control unit 38 is connected electrically to a transmission interface 36 via the SATA/USB control unit 37, to control the direct memory access in the computer through the transmission interface 36. The random access memory (RAM) control unit 42 is connected electrically to the CPU 12, so that it can control access of random access memory (RAM) in the computer.

Summing up the above, in the present invention, the storage space of a plurality of NAND flash memory card can be integrated into a larger storage space, to increase access speed. Also, the status of each NAND flash memory card can be detected in time, to inform the user to backup data or replace the damaged cards. As such, the damaged NAND flash memory card can be replaced separately, without the need to replace the whole storage device, thus achieving cost saving, speedy repair and maintenance, and simplified manufacturing process.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An intelligent detection device of solid state hard disks combining a plurality of NAND flash memory card, comprising:
a central processing unit (CPU);
a control unit, connected electrically to said central processing unit (CPU), and is under control of said CPU;
a plurality of flash card insertion slots, connected electrically to said control unit for inserting said plurality of said flashcards, and for said control unit to read parameters of said NAND flash memory card, said control unit transmits said parameters to said CPU, to determine status of each said NAND flash memory card; and
at least a status display unit, connected electrically to said CPU, to display status of each said NAND flash memory card under control of said CPU.

2. The intelligent detection device of solid state hard disks combining a plurality of NAND flash memory card as claimed in claim 1, wherein said status display unit includes a plurality of light emitting elements, each is located in said corresponding flash card insertion slot, so that each said light emitting element display status of each said NAND flash memory card under control of said CPU.

3. The intelligent detection device of solid state hard disks combining a plurality of NAND flash memory card as claimed in claim 2, wherein said light emitting element is a light-emitting-diode (LED).

4. The intelligent detection device of solid state hard disks combining a plurality of NAND flash memory card as claimed in claim 1, wherein said status display unit is a liquid crystal screen.

5. The intelligent detection device of solid state hard disks combining a plurality of NAND flash memory card as claimed in claim 1, further comprising: at least a transmission interface, connected electrically to a computer to transmit data, so that said computer display status of said NAND flash memory card.

6. The intelligent detection device of solid state hard disks combining a plurality of NAND flash memory card as claimed in claim 5, wherein said transmission interface is a Universal Serial Bus (USB) or a serial ATA.

7. The intelligent detection device of solid state hard disks combining a plurality of NAND flash memory card as claimed in claim 1, further comprising: a programmable read-only-memory (PROM), connected electrically to said CPU.

8. The intelligent detection device of solid state hard disks combining a plurality of NAND flash memory card as claimed in claim 5, further comprising: A direct memory access (DMA) control unit, connected electrically to said CPU, so that said direct memory access control unit controls direct memory access in said computer.

9. The intelligent detection device of solid state hard disks combining a plurality of NAND flash memory card as claimed in claim 5, further comprising: a random access memory (RAM) control unit, connected electrically to said CPU, so that said random memory access control unit controls access of random access memory (RAM) in said computer.

10. The intelligent detection device of solid state hard disks combining a plurality of NAND flash memory card as claimed in claim 1, wherein said control unit reads spare field, reserved block, and User Defined Registers in each said NAND flash memory card.

11. The intelligent detection device of solid state hard disks combining a plurality of NAND flash memory card as claimed in claim 1, wherein said control unit reads parameter Erase Count, to determine service life of said NAND flash memory card.

12. The intelligent detection device of solid state hard disks combining a plurality of NAND flash memory card as claimed in claim 1, wherein said parameter read by said control unit are Error-Correcting Code, Program/Erase status, Cyclic Redundancy Check (CRC), Parity Check, User Defined Parameter, Bad Block Number, to determine status of said NAND flash memory card.

13. The intelligent detection device of solid state hard disks combining a plurality of flash memory cards as claimed in claim 1, wherein said CPU is provided with a Self-Monitoring Analysis And Reporting Technology (SMART) command, for it to send orders through said control unit to read and determine status of said flash memory cards.

14. The intelligent detection device of solid state hard disks combining a plurality of flash memory cards as claimed in claim 1, wherein said CPU is provided with a Vendor Specific Command, for it to send orders through said control unit to read and determine status of said flash memory cards.

15. A detecting method for an intelligent detection device of solid state hard disks combining a plurality of NAND flash memory card, comprising the following steps:
A. read a plurality of NAND flash memory card, and transmit flash Identification of said NAND flash memory card back to a central processing unit (CPU) to determine Flash Identification of said NAND flash memory card;
B. read parameters of said NAND flash memory card, and transmit said parameters of said NAND flash memory card back to said CPU, to determine statuses of said NAND flash memory card; and
C. send out a display signal based on status of said NAND flash memory card, to display status of said NAND flash memory card, and continue executing step B.

16. The detecting method for an intelligent detection device of solid state hard disks combining a plurality of NAND flash memory card as claimed in claim 15, wherein
said display signal of said step C is to display lights of different colors based on status of each said NAND flash memory card.

17. The detecting method for an intelligent detection device of solid state hard disks combining a plurality of NAND flash memory card as claimed in claim 16, wherein
when said NAND flash memory card are in a normal status, a status display unit displays green light; when said NAND flash memory card are slightly damaged and requiring data backup, said status display unit displays yellow light;
and when said NAND flash memory card are damaged, said status display unit displays red light.

18. The detecting method for an intelligent detection device of solid state hard disks combining a plurality of NAND flash memory card as claimed in claim 15, wherein
in said step b, spare field, reserved block, and User Defined Registers of each said NAND flash memory card are read.

19. The detecting method for an intelligent detection device of solid state hard disks combining a plurality of NAND flash memory card as claimed in claim 15, wherein
in said step b, Erase Count is read to determine service life of each said NAND flash memory card.

20. The detecting method for an intelligent detection device of solid state hard disks combining a plurality of NAND flash memory card as claimed in claim 15, wherein
in said step b, Error-Correcting Code (ECC), Program/Erase status, Cyclic Redundancy Check (CRC), Parity Check, User Defined Parameter, Bad Block Number are read, to determine status of each said NAND flash memory card.
